(19) United States
(12) Patent Application Publication
(10) Pub. No.: US 2004/0091236 A1
(43) Pub. Date: May 13, 2004

(54) User specific cable/personal video recorder preferences

(75) Inventors: Stephen B. Boston, Cedar Park, TX (US); Michael Wayne Brown, Georgetown, TX (US); Michael A. Paolini, Austin, TX (US)

Correspondence Address: BRACEWELL & PATTERSON, L.L.P., P.O. BOX 969, AUSTIN, TX, 78767-0969, US

(73) Assignee: International Business Machines Corp., Armonk, NY

(21) Appl. No.: 10/290,221

(22) Filed: Nov. 7, 2002

(51) Int. Cl. H04N 5/76; H04N 5/781

(52) U.S. Cl. 386/46; 386/125

(57) ABSTRACT

In an exemplary embodiment of the present invention, an operator of a personal video recorder (PVR) identifies himself or herself to a personal video recorder (PVR) as the current user. The identification maybe accomplished by a number of means including the use of a personal identification number (PIN), a user name and password, or through a trusted third party. Once the current user of the PVR is identified, the afterwards indicated preference settings (i.e. thumbs up/down) are stored in a manner as to relate the preference setting with the user. With the PVR able to distinguish preferences for each user, the PVR may automatically record programming for a particular user without regard to preferences specified by other users.

### CROSS REFERENCE TO RELATED APPLICATIONS

The present application shares specification text and figures with the following co-pending applications, which were filed concurrently with the present application: application Ser. No. ______ (Attorney Docket Number AUS920020417US1) “PVR Credits by User;” and application Ser. No. ______ (Attorney Docket Number AUS920020416US1) “Fee-Based Programming Charge Based on Content Viewed by User.” The content of the co-pending applications are incorporated herein by reference.

### BACKGROUND OF THE INVENTION

1. Technical Field

The field of the invention is data processing, or, more specifically, methods, systems, and products for a user specific preferences for use in conjunction with a personal video recorder device.

2. Description of the Related Art

The use of personal video recorders (PVRs) has become increasingly common. PVRs function similar to a video cassette recorder (VCR) with the notable exception of utilizing a digital storage device, such as a hard drive, for storing data. Also, PVRs present additional features not previously found in VCRs such as automatic recording of programming based on a specified preference. The current operator of the PVR may specify a thumbs up or a thumbs down indicating a preference for the type of show being watched. Once the PVR obtains a set of preferences, the PVR may automatically record programming in accordance with the specified preferences.

While the term cable is utilized in the Specification of the present invention, the term is meant to include all forms and providers of electronic video data.

In situations where multiple people utilize a PVR, conflicting thumbs up and thumbs down may be specified for a type of programming. The conflicting preference specification may prevent the PVR from recording programming which one of the users may enjoy thereby decreasing the usefulness of the automatic recording. Therefore, a need exists for a user specific thumbs up/down preference specification.

### SUMMARY OF THE INVENTION

In an exemplary embodiment of the present invention, an operator of a personal video recorder (PVR) identifies himself or herself to a personal video recorder (PVR) as the current user. The identification maybe accomplished by a number of means including the use of a personal identification number (PIN), a user name and password, or through a trusted third party. Once the current user of the PVR is identified, the afterwards indicated preference settings (i.e. thumbs up/down) are stored in a manner as to relate the preference setting with the user. With the PVR able to distinguish preferences for each user, the PVR may automatically record programming for a particular user without regard to preferences specified by other users.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed description of an illustrative embodiment when read in conjunction with the accompanying drawings, wherein:

FIG. 1 is an exemplary block diagram illustrating a personal video record as may be utilized by the present invention;

FIG. 2 is a pictorial representation of aspects of user identification means in which exemplary embodiments of the present invention may be implemented;

FIG. 3 is a flowchart depicting a set of steps that may be carried out to obtain a user specific preference in conjunction with a PVR device;

FIG. 4 is a flow chart illustrating a set of steps taken in a preferred embodiment of the present invention to identify a current user;

FIG. 5 is a flowchart depicting a set of steps for initializing a personal video recorder for multi-user operation;

FIG. 6 is a pictorial representation of a user interface allowing a personal video recorder to obtain user information;

FIG. 7a is a pictorial representation of a user interface allowing the indication of which preference a user wishes to specify;

FIG. 7b is a pictorial representation of a user interface allowing the specification of a user preference for viewed programming;

FIGS. 8a-c illustrate a set of tables utilized in an embodiment of the present invention for associating a user preference with a particular user;

FIG. 9 is a flow chart illustrating a set of steps for resolving recording conflicts by different users of a personal video recorder;

FIG. 10a is a flow chart depicting a set of steps for recording programming in patches when a personal video recorder is unable to record programming due to a conflict;

FIG. 10b is a flow chart illustrating a set of steps for recording patches of programming;

FIG. 11a is a pictorial representation of a user interface for a personal video record to indicate system-wide preferences for programming;

FIG. 11b is a pictorial representation of a user interface for a personal video record to list recordings for a particular user; and

FIG. 12 is a pictorial representation of a user interface for a personal video record to list all recordings in the system.

### DETAILED DESCRIPTION OF THE PREFERRED EMBODIMENT

Referring now to the drawing figures, in which like numerals indicate like elements or steps throughout the several views, the preferred embodiment of the present invention will be described. In general, the present invention provides for a user specific preference in conjunction with a personal video recorder device.

While the term cable is utilized in the Specification of the present invention, the term is meant to include all forms and providers of electronic video data.

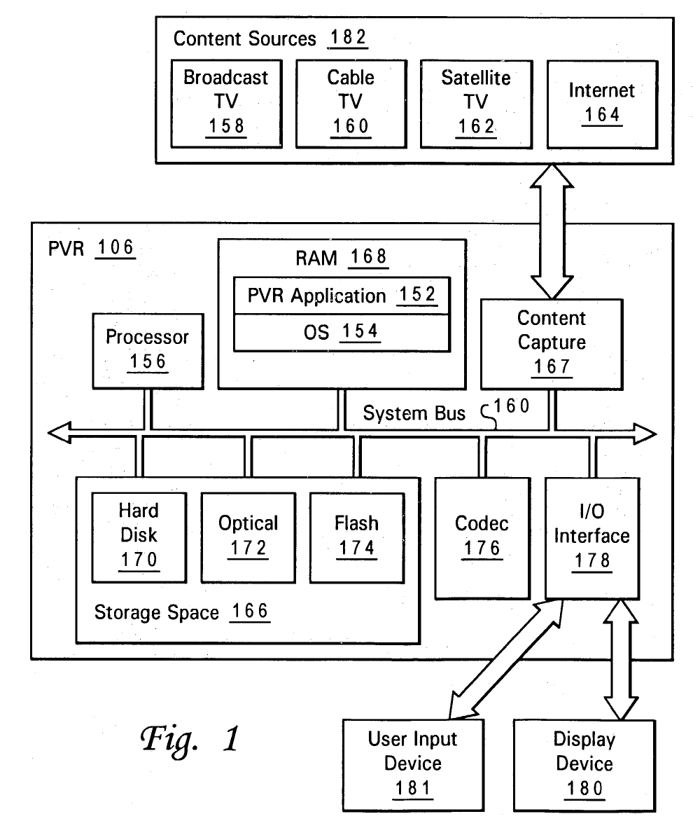

With reference now to FIG. 1, an exemplary block diagram illustrating a personal video recorder as may be utilized by the present invention is shown. FIG. 1 sets forth a block diagram of automated computing machinery comprising a PVR 106 according to an exemplary embodiment of the present invention. PVR 106 of FIG. 1 includes at least one computer processor 156 as well as random access memory (RAM) 168. Stored in RAM 168 is a PVR application program 152 implementing inventive steps of the present invention.

Also stored in RAM 168 is an operating system (OS) 154. Embodiments of the present invention are directed towards personal video preference settings for multiple users. It will occur to readers skilled in the art that much of the work of administering user accounts for many users may be downshifted to a multi-user operating system such as Unix, Linux, or Microsoft NT™. The multi-user features of typical embodiments of the present invention, however, tend to be features of application software. PVRs according to embodiments of the present invention, therefore, may use single-user operating systems, such as Microsoft's Disk Operating System or “DOS,” as well as multi-user operating systems, or even operating systems developed as special purpose systems for use in PVR according to this invention.

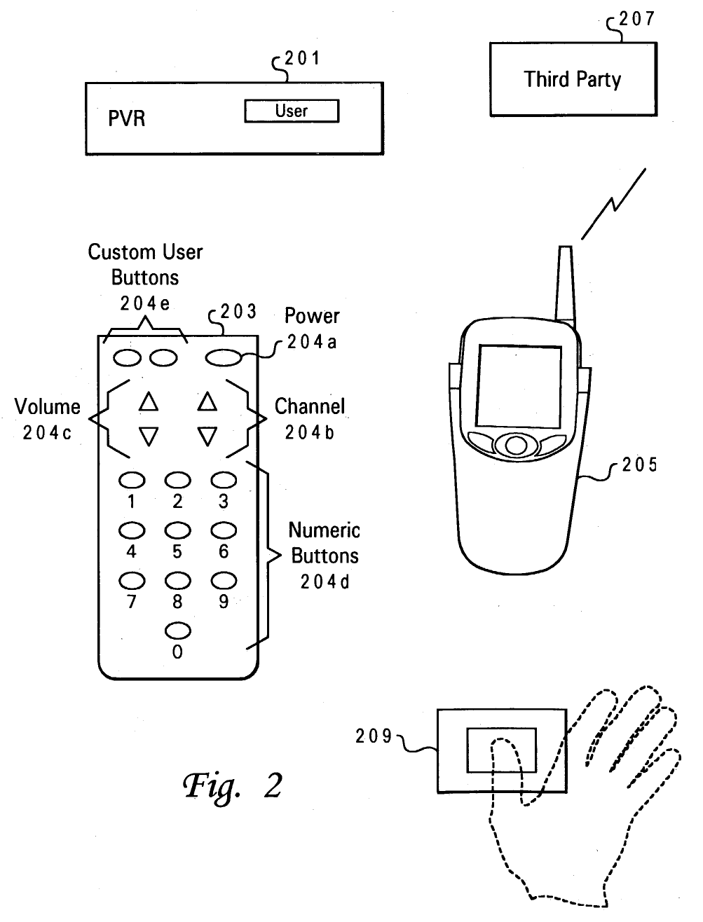

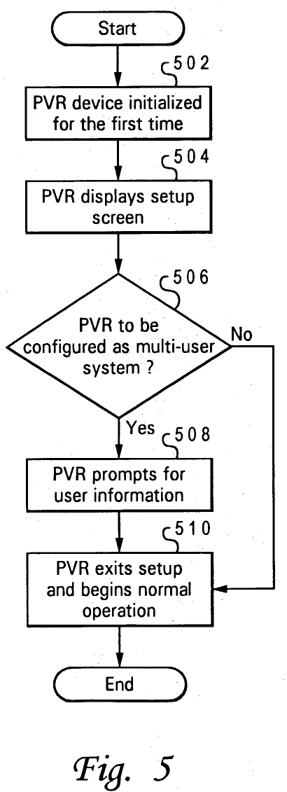

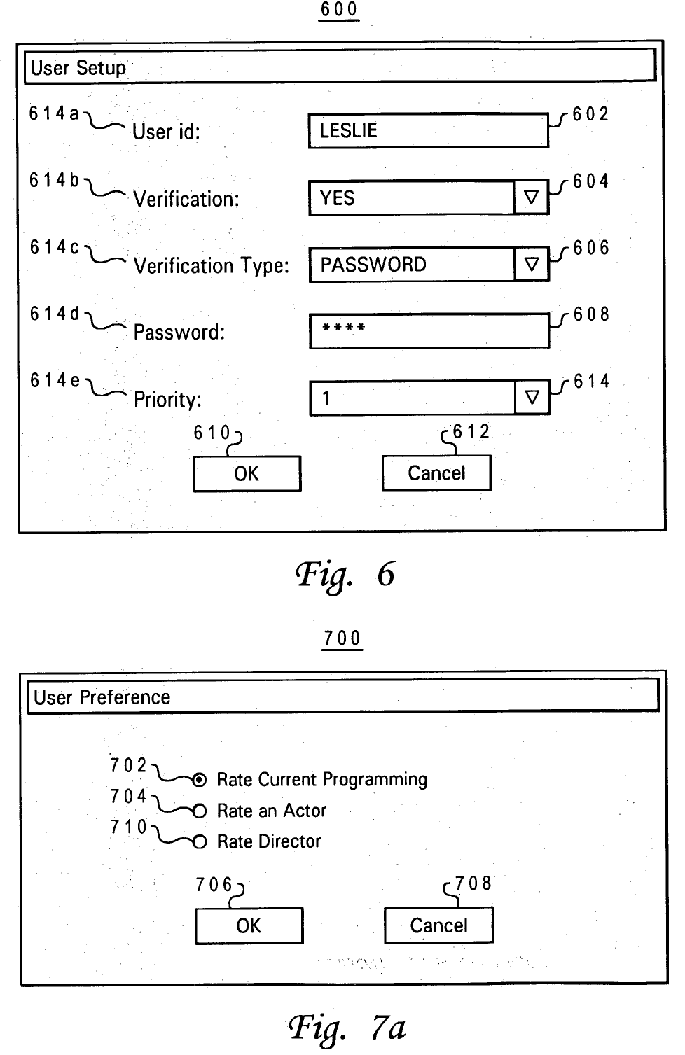

RAM 168 includes software instructions for configuring PVR 106 to identify users. In a preferred embodiment, RAM 168 includes instructions that prompt a user of PVR 106 to specify the users of PVR 106 during the initial setup of PVR 106. The specification of the users may take the form of specifying to PVR 106 through an input device the names or and identification code of the individuals who will utilized PVR 106. Following the input of the user names or identification code, PVR 106 optionally requests each user to specify a verification procedure to be utilized in identifying the user. Various methods of identifying a user are discussed more in detail in conjunction with FIG. 2. For systems that no users are specified or in conditions in which no user is specified, a default user is assumed. Additionally, the default user may serve as a “guest” user. If a user logs off as the current user, the default user is assumed. PVR 106 setup is discussed in more detail in conjunction with the description of FIG. 5 and FIG. 6.

In a preferred embodiment, RAM 168 includes storage space for storing user specific preferences and/or account information. Additionally, RAM 168 contains application software required to obtain and verify the current one or more users of PVR 106. A portion of RAM 168 is allocated to storing information to associate thumbs up/down input with a specific user.

PVR 106 includes storage space 166 for programming. Storage space 166 may be implemented as hard disk space 170, optical drive space 172, electrically erasable programmable read-only memory space (EEPROM or Flash memory) 174, RAM drives (not shown), or as any other type of computer memory capable of receiving and storing recorded content.

The example PVR 106 includes a subsystem for content capture 167. The subsystem for content capture 167 is implemented in typical embodiments according to content sources 182 and may include in various embodiments a broadcast television tuner for receipt of broadcast television 158, a cable box for receipt of cable television 160, a satellite receiver for receipt of satellite television 162, and an Internet connection for downloading recordable content from the Internet 164.

PVR 106 includes a codec 176, which may take the form of a video card logically connected to the system bus of a personal computer, or other forms as will occur to those of skill in the art. Codec 176 provides video and audio output from recorded programming in storage space 166 to an input/output interface 178. Additionally, codec 176 may also provide changes in video compression or video quality as needed in particular instances. The input/output interface provides video and audio output to a display device 180. In the case of PVRs implemented with connection to televisions, the display device 180 is a television. In the case of PVRs implemented as general purpose computers, the display device is often implemented as a computer screen. Display device 180 is any device, as will occur to those of skill in the art, capable of displaying video and audio content.

PVR 106 includes an input/output interface 178. The input/output interface 178 in PVRs implemented as general purpose computers is a computer interface including, for example, conventional software drivers and computer hardware for controlling output to display devices 180 such as computer screens, as well as user input from user input devices 181 such as computer keyboards and computer mice. In the case of PVRs as set top boxes, an input/output interface 178 comprises, for example, software drivers and computer hardware for controlling displays on display devices 180 such as television screens and user input from user input devices 181 such as remote control devices. A user may specify a thumbs up/down utilizing input/output interface 178.

In the present invention, user input device 181 provides a means for identification of a particular user. User input device 181 may take the form of a remote control, keyboard, or any other device capable of transmitting user identification such as biometric scanners. User input device 181 may by a wireless device, such as a Bluetooth-enabled cellular phone. User input device 181 may take the form of a wireless device with an identification which may be verified by a trusted third party. Devices that may serve as user input device 181 are discussed below in conjunction with FIG. 2.

Those skilled in the art will readily appreciate the PVR described in conjunction with FIG. 1 may take the form of a cable box without departing from the spirit and scope of the present invention.

Now with reference to FIG. 2, a pictorial representation of aspects of user identification means in which exemplary embodiments of the present invention may be implemented is shown. PVR 201 is substantially similar to PVR 106 as described in FIG. 1.

Remote control 203 communicates with PVR 201 via infrared transmission or radio frequency transmission or any other manner known by those skilled in the art. In an exemplary embodiment of the present invention, remote control 203 contains custom buttons allowing an operator of PVR 201 to specify the current user by pressing a single button. Alternative embodiments include the use of a single button followed by the entry of a personal identification number (PIN). The PIN provides a means for ensuring the current operator is indeed the designated user.

In yet another embodiment, remote control 203 takes the form of typical remote control for the operation of PVR 201. Remote control 203 contains volume buttons 204c and channel buttons 204b. The user enters an optional username and a PIN utilizing numeric buttons 204d. Additionally, remote control 203 may include a special button for the communicating to PVR 201 that user information is to be subsequently entered. These special buttons may take the form of custom user buttons 204e. In an alternative embodiment, custom user buttons 204e are utilized to specify the current user with no further input. One of custom buttons 204e is pressed to indicate a user is now operating the system. The button is pressed a second time to indicate the user is no longer operating the system.

In still another embodiment, each user of PVR 201 has an individual remote control. When the remote control is in communicative contact with PVR 201 a user identification is transmitted allowing PVR 201 to determine the current user.

Those skilled in the art will readily appreciate that remote control 203 may be implemented as a set of buttons directly attached to PVR 201 without departed from the spirit and scope of the present invention.

Wireless device 205 communicates with PVR 201 utilizing radio frequency transmission or any other means known in the art. Specifically, wireless device 205 may communicate with PVR 201 utilizing any 802.11 or Bluetooth wireless standards. In an exemplary embodiment, wireless device 205 may be a mobile phone. The mobile phone may communicate with PVR 201 as a remote control described previously. Alternatively, PVR 201 may utilize third party 207 to authenticate a user.

Biometric device 209 is logically connected to PVR 201. The connection between biometric device 209 and PVR 201 may take the form of a physical link or wireless link. Biometric device 209 identifies a user based on a physical attribute such as fingerprint, voice print, retinal image, or any other means known in the art.

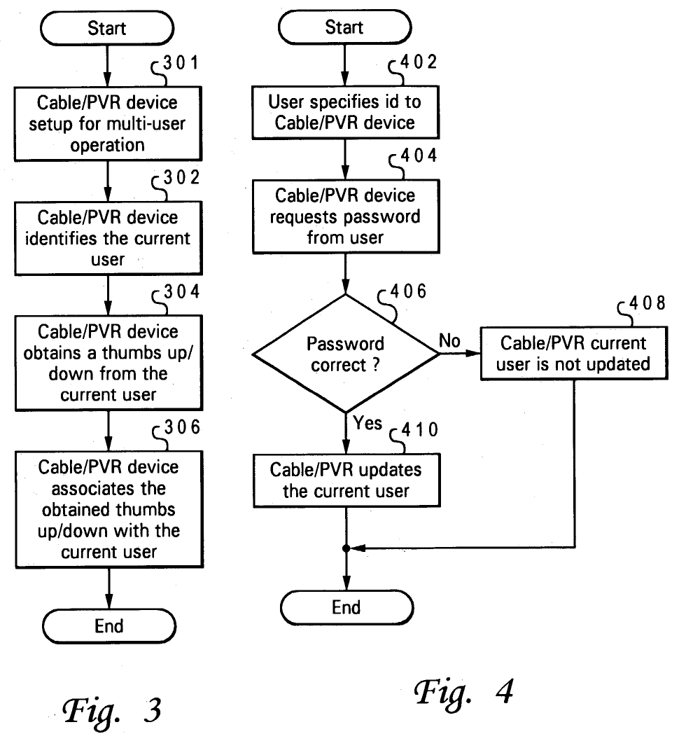

With reference now to FIG. 3, a flow chart illustrating a set of steps that may be taken to perform the present invention are shown. In the exemplary embodiment described, the user specific preference specified is a thumbs up/down for programming being viewed. In alternative embodiments, other user preferences are specified, such as programming or actor rating based on a range of values indicating strongly dislike to strongly like. Preference ratings may be indicated with numeric ranges, alphabetical ranges, or icons indicating the user preference for the category being rated.

The process begins as depicted at step 301 with the PVR device configured for multi-user operation. Upon initializing the device the first time, or at a later time if desired by a user, the PVR obtains user identification information. To setup multi-user operation, a user specifies an identifier to the PVR device and an optional identity verification. The optional identity verification means include the utilization of a PIN, password, biometric, or third-party verification.

The process continues as depicted at step 302 with the PVR device identifying the current user. The current user is identified by any of the means discussed in conjunction with FIG. 2. The general scheme of identifying a user comprises of obtaining a token from a user, such as an id, biometric, button press, etc., and optionally verifying the token with a pin, password, or a third party. A more detailed description of user identification and verification is provided in conjunction with the description of FIG. 4.

Following the identification of the current user (step 302), the process continues as illustrated at step 304 with the PVR device obtaining a thumbs up/down from the current user for the programming being viewed. The thumbs up/down is specified in a traditional manner such as a specific button for “thumbs up” and one for “thumbs down” in a preferred embodiment. In alternative embodiments, the user selects thumbs up/down from a menu screen or other ways known in the art for inputting data to the PVR device. The specification of a user preference is discussed in more detail in conjunction with the description of FIG. 7a and FIG. 7b.

The thumbs up/down acquired (step 304) by the PVR device is associated with the current user as depicted at step 306. In a preferred embodiment, the PVR stores the thumbs up/down information in storage substantially similar to RAM 168 in FIG. 1. The PVR storage includes a data structure, such as a table, for users known to the system for managing thumbs up/down information.

Now referring to FIG. 4, a flow chart illustrating a set of steps taken in a preferred embodiment of the present invention to identify a current user are shown. In the preferred embodiment presented, user identification verification is performed utilizing a password which is obtained during user setup.

The process begins as depicted at step 402 with the PVR device obtaining an identification from a user of the PVR device. The identification may be a user name or an alpha-numeric id specified by any of the means described in conjunction with FIG. 2.

Following the input of a user id (step 402), the PVR device requests a password to be specified by the user as illustrated at step 404. The user may utilize any input device logically connected to the system to specify the password. In a preferred embodiment, the password is a four digit number specified at the time a user is setup with the PVR device.

A determination is made at step 406 as to whether the password entered by the user is correct. Such determination may be made utilizing instructions store in memory of the PVR device which compare the inputted password with the password stored in memory associated with the entered user id.

If the password obtained by the PVR device is incorrect, the process advances as illustrated to step 408. Following the unsuccessful verification of a user, the PVR device state is unchanged, leaving the previous system user as the current user. In alternative embodiments, the current user is specified to the default user following a failed identification verification.

If the password entered by the user is determined correct as step 406, the process continues to step 410 which illustrates the PVR device updating the current user of the system. Following the change in current users, the system stores all preferences entered into the system as belonging to the current user until the current user logs off or a different user logs on.

With a PVR device able to store user specific preferences, the PVR device is able to automatically record programming a user is likely to enjoy based on the preferences supplied. This may be accomplished even if different users specify conflicting preferences which under prior art systems would have undesirable results.

Referring now to FIG. 5, a flow chart showing a set of steps to initialize a personal video recorder for multi-user operation is depicted. The process begins when the device is initialized for the first as illustrated at step 502. Alternatively, a user may enter PVR setup at other times by pressing a “SETUP” button on a remote control or by other similar means.

Afterwards, the PVR displays a setup screen to the current operator as depicted at step 504. The setup screen prompts the operator for any information concerning the configuration of the PVR and any additional settings. Additionally, the PVR prompts the operator if the PVR is to function in multi-user mode. During PVR setup, the PVR automatically adds a default user to the system. The default user profile is utilized by the system when no other user has been specified as the current user.

If, as depicted at step 506, the PVR is to be configured as a multi-user system, the process advances to step 508 illustrating the PVR prompting the operator for user information. More details describing the prompting for user information are described in conjunction with FIG. 6.

Following the entering of user information (step 508), or if the operator does not wish to configure the PVR for multi-user mode, the process continues to step 510 which depicts the PVR exiting setup and beginning normal operation. Normal operation in this case refers to the functioning of the PVR outside of the configuration process, such as viewing or recording programming.

Now referring to FIG. 6, a pictorial representation of a user interface utilized in a preferred embodiment to obtain user information is shown. Screen 600 contains various controls allowing a PVR to obtain information from a user. In the embodiment depicted, the dialog controls are utilized to display and receive input. A user may specify data to the PVR by any of the means discussed in conjunction with FIG. 2. Screen 600 includes static text boxes 614a-e that prompt the user to enter a particular type of data, such as the user id. Static text boxes 614a-d may present information in various languages. Additionally, static text box 614d may be changed depending on the type of verification selected in drop list 606.

Input graphical components allow the PVR device to obtain input from a user in Screen 600 to set up a user account Edit box 602 permits a operator to specify the user id for the user profile being entered. Drop list 604 allows an operator to decide if verification is required to change the current user of the PVR to the user profile being entered. If verification is required, drop list 606 allows the operator to decide the type of verification to be utilized. In screen 600 shown, the verification type selected is “password,” however, an operator may select third party, biometric, or any other means of verification. Edit box 608 allows the operator to enter the password necessary to switch the current user of the PVR to the profile being entred. The personal video recorder obtains a user priority (static text label 614e) via drop list 614. In alternative embodiments, the input device is an edit box.

Upon the completion of data entry into screen 600, an operator may select button 610 to save the current data, or select button 612 to cancel the entry of current profile.

With reference now to FIG. 7a and FIG. 7b, a pictorial representation of a user interface for a PVR to obtain a user preference is shown. Screen 700 allows the specification of which type of preference a user would like to specify. The user selects an available preference type such as those depicted by radio buttons 702, 704, and 710. Those skilled in the art will readily understand that additional items to rate may be presented to the user such as the year, rating, genre, time of day, or other characteristics of the programming. Following the selection of a preference type, button 706 is pressed to continue the specification of a user preference for the chose preference type, or button 708 is pressed to abort the input of a user preference.

Following the pressing of button 706 to input the preference for the current programming, screen 720 is displayed to the current user. Screen 720 includes static text 722 to indicate the current user of the system in order to ensure the preference is being specified for the correct user. Static text 724 prompts the user to indicate a numerical rating of the currently viewed programming. Additionally, static text 728 provides additional information to the current user regarding the meaning of the numerical value to be entered. Edit box 726 allows the entry of the user preference for the current programming. Button 730 may be depressed to save the specified preference in the current user profile, otherwise, button 732 may be depressed to abort the process of entering a user preference.

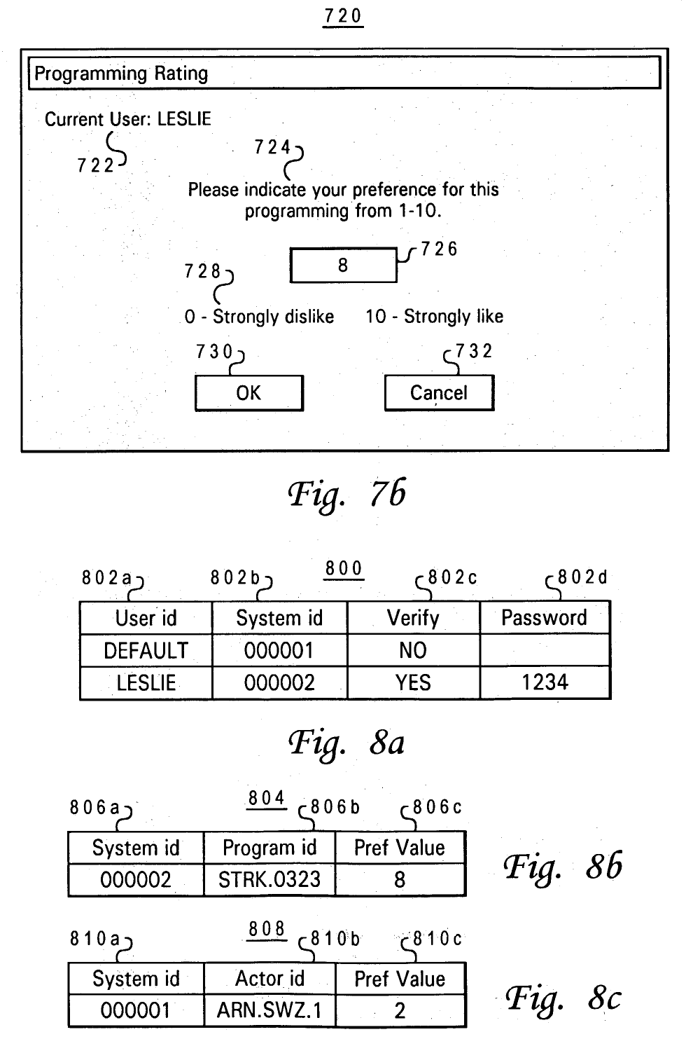

Now with reference to FIG. 8a, FIG. 8b, and FIG. 8c, a chart representation of a database that may be utilized to associate a user preference with a particular user is shown. The tables shown in FIGS. 8a-c are storing in PVR storage that is substantially similar the RAM 168 illustrated in FIG. 1.

Table 800 contains a listing of all users of the PVR. For a PVR not configured in multi-user mode, table 800 will contain only one entry for the default user. Table 800 contains column 802a for storing a user id, column 802b for associating a system id with a user id, column 802c for indicating if a user id needs to be verified, and column 802d for storing verification data for a user. The system id stored in column 802b is a system generated id utilized to logically link a user with preferences stored in tables 804 and 806. The use of a system id rather than the user id permits the release of user preferences stored in tables 804 and 806 to third parties without indicating the identity of the user.

Table 804 contains user preferences for programming viewed by users of the PVR. Table 804 contains column 806a for storing a system id utilized to associate the data row to a particular user, column 806b to indicate the program to which the preference belongs, and column 806c for storing the preference value for the program.

Table 808 contains user preferences for actors in programming viewed by users of the PVR. Table 808 contains column 810a for storing a system id utilized to associate the data row to a particular user, column 810b to indicate the actor to which the preference belongs, and column 810c for storing the preference value for the actor.

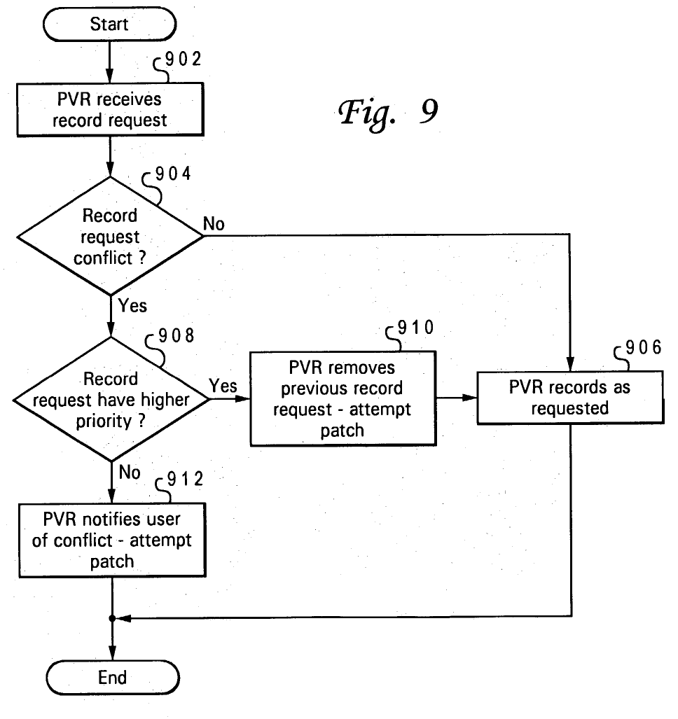

Referring now to FIG. 9, a flow chart for handling recording request conflicts by different users of a personal video record is illustrated. As depicted at step 902, the process begins when a PVR receives a current record request. A record request occurs when a user indicates to the personal video record that programming should be recorded or when the personal video recorder (PVR) determines programming should be recorded on behalf of a user based on a user's preferences.

After receiving a record request, the PVR determines if there is a conflict with the record request as illustrated at step 904. To determine the presence of a conflict, the PVR examines a table of programming to be recorded and determines if any entries in the table overlap the current record request. If no conflict exists, the process continues to step 906 which depicts the PVR recording the programming as requested.

Otherwise, if a conflict exists, the process continues to step 908 depicting the PVR determining if the current record request has a higher priority than all other conflicting record requests. The priority of a record request is based on the priority of the user for which the record request was entered. In alternative embodiments, the priority for a record request is based on factors such as time of day, number of user recordings, and type of programming to be recorded.

If the current record request has a higher priority than all conflicting record requests (determined at step 908), the conflicting record requests are removed from the recording table as depicted at step 910. The process then continues as illustrated at step 906 with the PVR recording the programming as requested.

If the current record request has a lower priority than any conflicting record requests (determined at step 908), the current record request is not entered and the PVR notifies the user of the conflict.

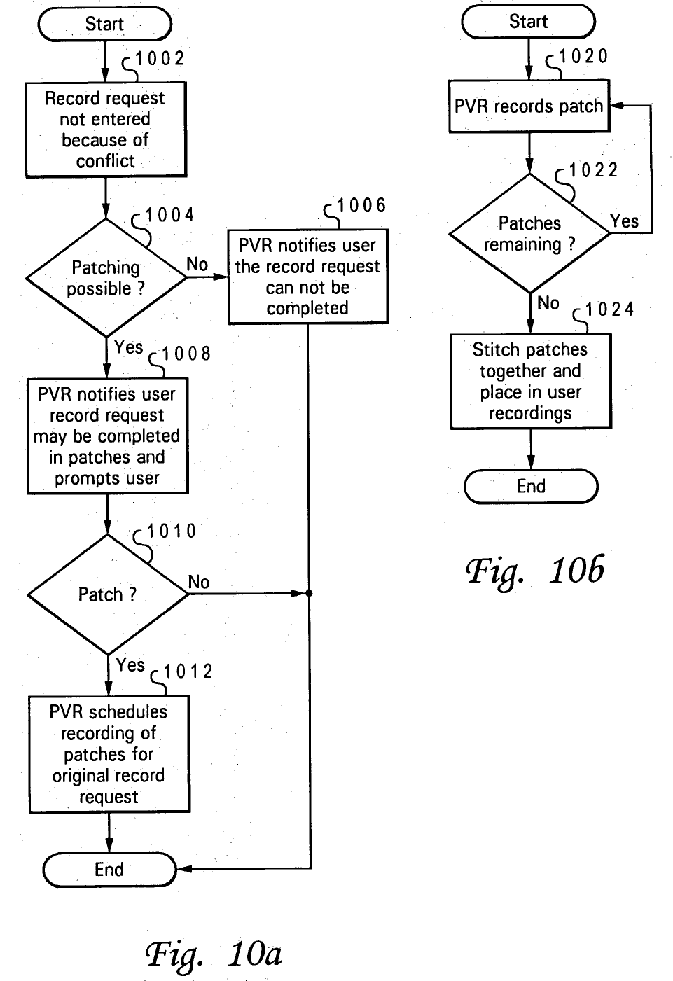

In response to the conflicting record request being removed (step 910) or the current record request not being entered (step 912), the PVR will attempt to accomplish the not entered or removed record request by patching segments of the show as is further described in conjunction with FIG. 10a.

Now with reference to FIG. 10a-b, flow charts depicting a set of steps for recording patches of programming due to conflicting record requests by different users are shown. Two record request may conflict yet not overlap entirely and the conflicting portion may be available for recording at an alternate time. Systems in the prior art will not record any portion of a record request if any conflict is present at any part of the request.

With specific reference to FIG. 10a, the process for recording patches of programming begins as illustrated at step 1002 with a record request not being entered because of a conflict with another record request. A record request that is not entered because of a conflict with another record request or a record request that has been remove due to a conflict is referred to as a cancelled record request. The personal video recorder (PVR) determines if the cancelled record request is available for recording in segments, also called patches, as illustrated at step 1004. If patching is not possible, the process continues to step 1006, which depicts the PVR notifying the user that the record request can not be completed. Otherwise, if the PVR determines that patching is possible for the cancelled record request, the process continues to step 1008, which illustrates the PVR notifying the user that the cancelled record request may be completed by patching.

As depicting at step 1010, the PVR accepts input from a user indicating if the user would like the PVR to complete the cancelled record request through patching. If patching is not selected for the record request, the process ends with the cancelled record request not being recorded. Otherwise, if patching is selected, the process continues to step 1012, which illustrates the PVR scheduling the recording of the patches for the cancelled record request.

With specific reference to FIG. 10b, the process of recording patches of programming and stitching the patches together after a user or the personal video recorder (PVR) has determined to complete a record request through patching is shown. Before the process begins, the PVR has scheduled the patches of the record request to be recorded. As depicted at step 1020, the process resumes with the PVR recording a patch of a record request. After the patch is recorded, the PVR determines if any patches remain to be recorded as illustrated at step 1022. If patches remain to be recorded the process waits for the next patch to be recorded. Otherwise, the PVR stitches the patches together and places the stitched recording in the user's recordings for user which initiated the record request.

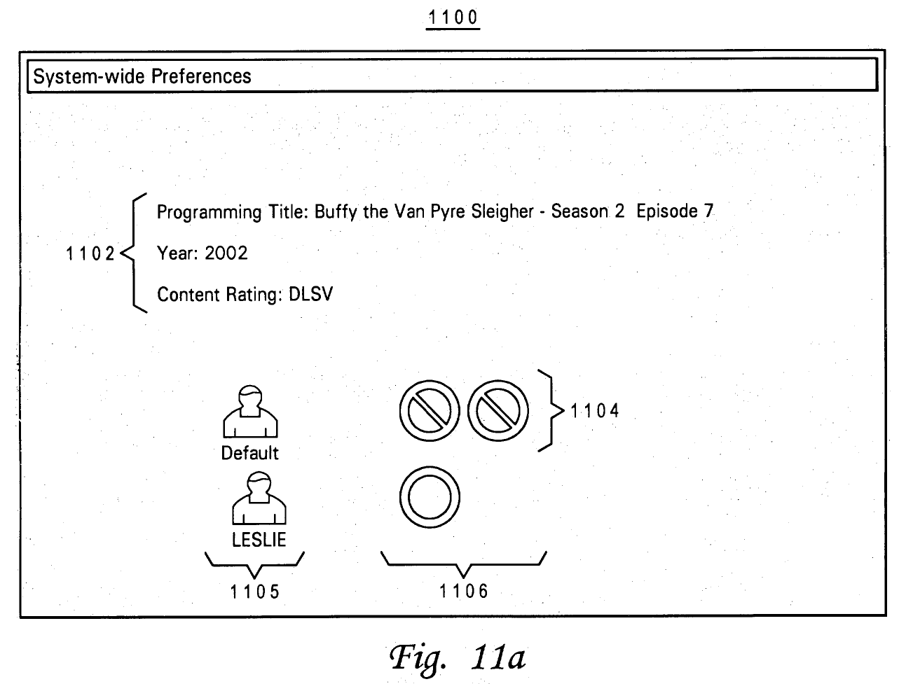

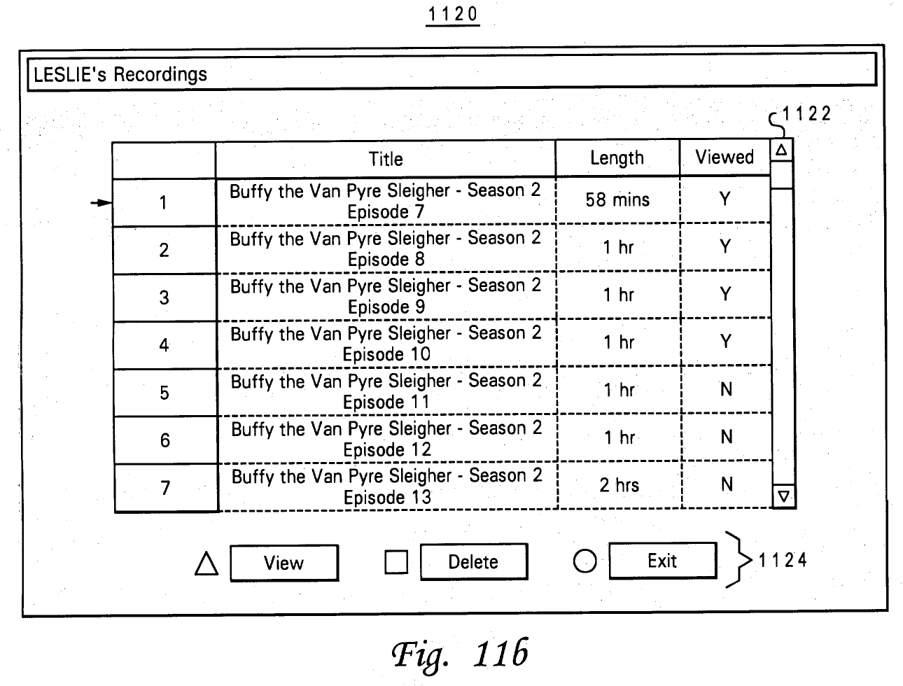

Referring now to FIG. 11a, a pictorial representation of a user interface for viewing system-wide preferences is shown. Screen 1100 contains a programming information block 1102 comprising text information describing the programming for which the system-wide preferences are being viewed. Additionally, screen 1100 contains user preference block 1104 comprising a user indicator 1105 and a preference indicator 1106. User indicator may take the form of an icon, color, text, or any means known in the art for indicating a user. Further, preference indicator 1106 may take any of the forms described in conjunction with FIG. 3.

Now with reference to FIG. 11b, a pictorial representation of a user interface for viewing recordings for a personal video recorder user is shown. Screen 1120 contains a recording table 1122 indicating the programming that has been recorded for a user and an indicator as to why a program was recorded, explicitly or implicitly. An explicitly recorded program is a program recorded specifically at the direction of a user. An implicitly recorded program is a program determined to be recorded by the personal video recorded based on the preferences of a user. In the example screen of FIG. 11b, the indicator is a letter, such that A=Actor, E=Explicit, D=Director and P=Producer. Those skilled in the art will readily appreciate that icons for the various types of preferences may be utilized.

Additionally, screen 1120 contain action buttons 1124 for viewing or deleting programming or for exiting the current screen. Recording table 1122 comprising rows indicating the title of the programming, the length of the programming, and if the user has viewed the programming. Further, action buttons 1124 are each associated with a special shape, such as a triangle, circle, or square, which correspond to a similarly shaped button on a remote control to allow for easy selection.

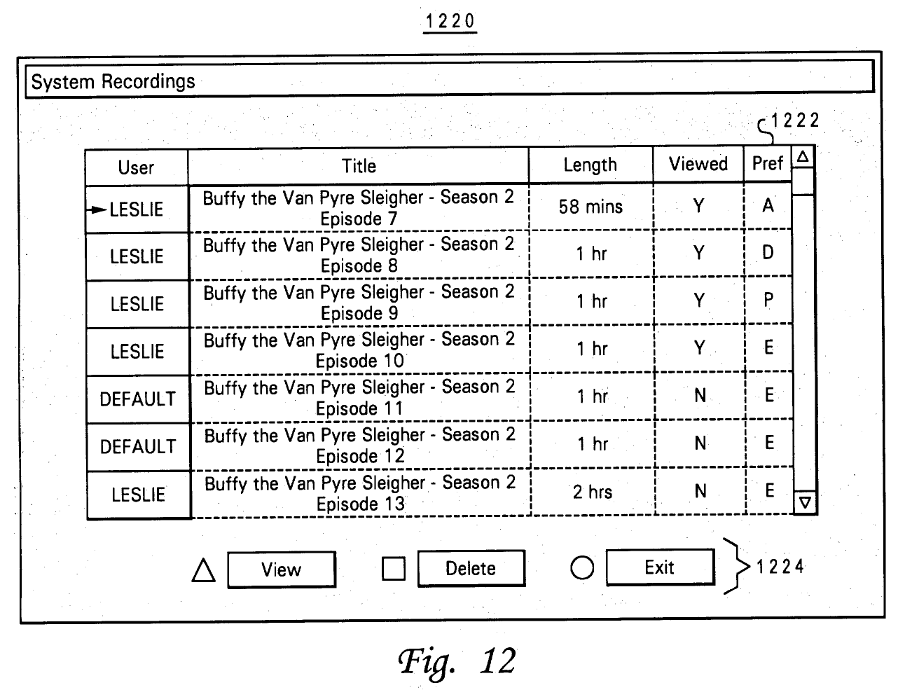

Referring now to FIG. 12, a pictorial representation of a user interface for viewing all recordings by the personal video recorder is shown. Screen 1220 contains a recording table 1222 indicating the programming that has been recorded for a user and an indicator as to why a program was recorded, explicitly or implicitly. Table 1222 also contains an indication of who the program was recorded for. As shown, the indication is the name of the user, however, in alternative embodiments, the identification may be accomplished by an icon or other representative symbol. Additionally, screen 1220 contains action buttons 1224 for viewing or deleting programming or for exiting the current screen. Recording table 1222 comprising rows indicating the title of the programming, the length of the programming, and if the user has viewed the programming. Further, action buttons 1224 are each associated with a special shape, such as a triangle, circle, or square, which correspond to a similarly shaped button on a remote control to allow for easy selection.

It will be understood from the foregoing description that modifications and changes maybe made in various embodiments of the present invention without departing from its true spirit. The descriptions in this specification are for purposes of illustration only and are not to be construed in a limiting sense. The scope of the present invention is limited only by the language of the following claims.

What is claimed is:

1. A personal video recorder system comprising:
means for specifying a plurality of users of the personal video recorder;
means for identifying a selected user among the plurality of users of the personal video recorder;
means for obtaining a preference from the selected user; and
means for recording programming in accordance with preferences obtained from the selected user.

2. The personal video recorder system of claim 1, wherein the means for recording programming comprises:
means for visually displaying a list of recorded programs, wherein said list includes an identity of the selected user among the plurality of users that each recorded program in the list of recorded programs was recorded for.

3. The personal video recorder system of claim 1, wherein the means for recording programming comprises:
means for accepting a current record request with a current record request priority, wherein said current record request priority is based on the selected user;
means for determining if the record request conflicts with a previous record request with a previous record request priority;
means for, in response to determining a conflict between the current record request and the previous record request, determining if the current record request priority is higher;
means for, in response to determining the current record request priority is not 11 higher, notifying the identified current user the current record request conflicts with the previous record request.

4. The personal video recorder system of claim 3, wherein the means for recording programming further comprises:
means for determining if a record request can be completed by recording a plurality of segments of the record request from different broadcasts, wherein the record request could not otherwise be recorded because of a conflict with another record request;
means for, in response to determining if the record request can be completed by recording the plurality of segments of the record request at different times, recording the plurality of segments and stitching the plurality of segments together to complete the record request.

5. The personal video recorder system of claim 2, wherein the list of recorded programs includes an indicator for specifying if each recorded program was recorded explicitly or implicitly.

6. The personal video recorder system of claim 5, wherein the indicator for specifying if each recorded program was recorded explicitly or implicitly is an icon representing a specific type of preference.

7. A method for operating a personal video recorder to accommodate multiple users, said method comprising the steps of:
specifying a plurality of users of the personal video recorder;
identifying a selected user among the plurality of users of the personal video recorder;
obtaining a preference from the selected user; and
recording programming in accordance with preferences obtained from the selected user.

8. The method of claim 7, wherein the step for recording programming comprises the step of:
visually displaying a list of recorded programs, wherein said list includes an identity of the selected user among the plurality of users that each recorded program in the list of recorded programs was recorded for.

9. The method of claim 7, wherein the step for recording programming comprises the steps of:
accepting a current record request with a current record request priority, wherein said current record request priority is based on the selected user;
determining if the record request conflicts with a previous record request with a previous record request priority;
in response to determining a conflict between the current record request and the previous record request, determining if the current record request priority is higher;
in response to determining the current record request priority is higher, removing the previous record request; and
in response to determining the current record request priority is not higher, notifying the identified current user the current record request conflicts with the previous record request.

10. The method of claim 9, wherein the step for recording programming further comprises the steps of:
determining if a record request can be completed by recording a plurality of segments of the record request from different broadcasts, wherein the record request could not otherwise be recorded because of a conflict with another record request;
in response to determining if the record request can be completed by recording the plurality of segments of the record request at different times, recording the plurality of segments and stitching the plurality of segments together to complete the record request.

11. The method of claim 8, wherein the list of recorded programs includes an indicator for specifying if each recorded program was recorded explicitly or implicitly.

12. The method of claim 11, wherein the indicator for specifying if each recorded program was recorded explicitly or implicitly is an icon representing a specific type of preference.

13. A computer program product for operating a personal video recorder to accommodate multiple users, said computer program product comprising:
instructions for specifying a plurality of users of the personal video recorder;
instructions for identifying a selected user among the plurality of users of the personal video recorder;
instructions for obtaining a preference from the selected user; and
instructions for recording programming in accordance with preferences obtained from the selected user.

14. The computer program product of claim 13, wherein the instructions for recording programming comprises:
instructions for visually displaying a list of recorded programs, wherein said list includes an identity of the selected user among the plurality of users that each recorded program in the list of recorded programs was recorded for.

15. The computer program product of claim 13, wherein the instructions for recording programming comprises:
instructions for accepting a current record request with a current record request priority, wherein said current record request priority is based on the selected user;
instructions for determining if the record request conflicts with a previous record request with a previous record request priority;
instructions for, in response to determining a conflict between the current record request and the previous record request, determining if the current record request priority is higher;
instructions for, in response to determining the current record request priority is higher, removing the previous record request; and
instructions for, in response to determining the current record request priority is not higher, notifying the identified current user the current record request conflicts with the previous record request.

16. The computer program product of claim 15, wherein the instructions for recording programming further comprises:
instructions for determining if a record request can be completed by recording a plurality of segments of the record request from different broadcasts, wherein the record request could not otherwise be recorded because of a conflict with another record request; and
instructions for, in response to determining if the record request can be completed by recording the plurality of segments of the record request at different times, recording the plurality of segments and stitching the plurality of segments together to complete the record request.

17. The computer program product of claim 14, wherein the list of recorded programs includes an indicator for specifying if each recorded program was recorded explicitly or implicitly.

18. The computer program product of claim 17, wherein the indicator for specifying if each recorded program was recorded explicitly or implicitly is an icon representing a specific type of preference.
